(19) United States
(12) Patent Application Publication
(10) Pub. No.: US 2024/0333654 A1
(43) Pub. Date: Oct. 3, 2024

(54) ACKNOWLEDGEMENT ENGINE FOR ROBUST ETHERNET COMMUNICATION TO REMOTE NODES

(71) Applicant: Analog Devices International Unlimited Company, Limerick (IE)

(72) Inventors: Isaac MOLINA, Valencia (ES); Seamus Anthony RYAN, Nenagh (IE)

(21) Appl. No.: 18/341,616

(22) Filed: Jun. 26, 2023

Related U.S. Application Data
(60) Provisional application No. 63/493,228, filed on Mar. 30, 2023.

(51) Int. Cl. H04L 47/34; H04L 47/32; H04L 67/12

(52) U.S. Cl. CPC H04L 47/34; H04L 47/32; H04L 67/12

(57) ABSTRACT

A method is provided for managing data between an ECU and a remote node. The aspects include receiving a PDU from the ECU and differentiating between mailbox data and streaming data being included in the PDU. The mailbox data is required to be received in order and to be intolerable of a data loss. The streaming data is tolerable of the data loss. The aspects include comparing a sequence number of the PDU found in a sequence number field of the PDU to an expected sequence number of the PDU, the sequence number of the PDU being: incremented by one for each transmitted frame; configured to roll over to one; and equal to zero only responsive to an unexpected reset of the remote node. The aspects include sending a message to the ECU indicating a mismatch, responsive to the sequence number of the PDU mismatching the expected sequence number.

### CLAIM OF PRIORITY

The present application claims priority to U.S. Provisional Application No. 63/493,228, filed on Mar. 30, 2023, and hereby incorporated herein by reference.

### BACKGROUND

This disclosure relates generally to Ethernet communication, more particularly, to an acknowledgement engine for robust Ethernet communication to remote nodes.

Automotive Ethernet connectivity is a key enabler of new, zonal architectures in automotive design and supports automotive megatrends like personalization, autonomy, and electrification. Ethernet has become the ubiquitous technology for backbone network connectivity across many industries, and it is proving to be a critical technology in the automotive world as well.

Ethernet to the Edge Bus (E²B) is a protocol for enhancing new architectures in that E²B removes the need for protocol translation to legacy networks. E2B centralizes software by moving software from edge nodes to central processing units, reducing software development and qualification tasks. E²B reduces system complexity in that a full hardware implementation of edge nodes simplifies design. Maintaining Ethernet all the way to the edge nodes provides a fully optimized Ethernet architecture utilizing time sensitive networking (TSN) to deliver quality of service and flexible address-based routing for dynamic network creation. The broad physical layer portfolio enables solutions for all situations. E²B has many other attendant advantages.

However, Ethernet networks can have frames dropped and/or duplicated and can also have out-of-order frames, which can reduce the robustness of the E²B protocol.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to aspects of the present disclosure, a computer-implemented method is provided for managing data between an Electronic Control Unit (ECU) and a remote node of a system. The method includes receiving, by the remote node, a Protocol Data Unit (PDU) from the ECU and differentiating between mailbox data and streaming data being included in the PDU responsive to a flag in a header of the PDU. The mailbox data is required to be received in order and to be intolerable of a data loss. The streaming data is tolerable of the data loss. The method further includes comparing, by the remote node, a sequence number of the PDU found in a sequence number field of the PDU to an expected sequence number of the PDU. The sequence number of the PDU is: incremented by one for each transmitted frame; configured to roll over from a particular maximum value to one; and equal to zero only responsive to an unexpected reset of the remote node. The method also includes sending, by the remote node, a message to the ECU indicating a mismatch, responsive to the sequence number of the PDU mismatching the expected sequence number.

According to other aspects, a computer program product is provided. The computer program product is configured to simulate various functions of remote nodes. The computer program product includes one or more non-transitory computer-readable media, having instructions stored thereon that when executed by one or more processors cause the one or more processors, individually or in combination, to perform a method. The method includes receiving, by the remote node, a Protocol Data Unit (PDU) from the ECU and differentiating between mailbox data and streaming data being included in the PDU responsive to a flag in a header of the PDU. The mailbox data is required to be received in order and to be intolerable of a data loss. The streaming data is tolerable of the data loss. The method further includes comparing, by the remote node, a sequence number of the PDU found in a sequence number field of the PDU to an expected sequence number of the PDU. The sequence number of the PDU is: incremented by one for each transmitted frame; configured to roll over from a particular maximum value to one; and equal to zero only responsive to an unexpected reset of the remote node. The method also includes sending, by the remote node, a message to the ECU indicating a mismatch, responsive to the sequence number of the PDU mismatching the expected sequence number.

According to further aspects, a remote node is provided for communicating with an Electronic Control Unit (ECU) in a system. The remote node includes one or more memories, individually or in combination, having instructions. The remote node includes one or more processors each coupled to at least one of the one or more memories and configurable to execute the instructions. The one or more processors execute the instructions to receive a Protocol Data Unit (PDU) from the ECU and differentiating between mailbox data and streaming data being included in the PDU responsive to a flag in a header of the PDU. The mailbox data is required to be received in order and to be intolerable of a data loss. The streaming data is tolerable of the data loss. The one or more processors further execute the instructions to compare a sequence number of the PDU found in a sequence number field of the PDU to an expected sequence number of the PDU. The sequence number of the PDU is: incremented by one for each transmitted frame; configured to roll over from a particular maximum value to one; and equal to zero only responsive to an unexpected reset of the remote node. The one or more processors also execute the instructions to send a message to the ECU indicating a mismatch, responsive to the sequence number of the PDU mismatching the expected sequence number.

According to still further aspects, a computer-implemented method is provided for managing data between an Electronic Control Unit (ECU) and a remote node of a system. The method includes sending, by the ECU, a Protocol Data Unit (PDU) to the remote node and differentiating between mailbox data and streaming data being included in the PDU responsive to a flag in a header of the PDU. The mailbox data is required to be received in order and to be intolerable of a data loss. The streaming data is tolerable of the data loss. The method further includes receiving, by the ECU, a message from the remote node indicating a mismatch, responsive to a sequence number of the PDU mismatching an expected sequence number of the PDU. The sequence number of the PDU is: incremented by one for each transmitted frame. configured to roll over from a particular maximum value to one, and equal to zero only responsive to an unexpected reset of the remote node.

According to yet still further aspects, an Electronic Control Unit (ECU) is provided for communicating with a remote node in a system. The ECU includes one or more memories, individually or in combination, having instructions. The ECU further includes one or more processors each coupled to at least one of the one or more memories and configurable to execute the instructions. The one or more processors execute the instructions to send a Protocol Data Unit (PDU) to the remote node and differentiating between mailbox data and streaming data being included in the PDU responsive to a flag in a header of the PDU. The mailbox data is required to be received in order and to be intolerable of a data loss. The streaming data is tolerable of the data loss. The one or more processors further execute the instructions to receive a message from the remote node indicating a mismatch, responsive to a sequence number of the PDU mismatching an expected sequence number of the PDU. The sequence number of the PDU is: incremented by one for each transmitted frame, configured to roll over from a particular maximum value to one, and equal to zero only responsive to an unexpected reset of the remote node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a block diagram of an example communication system having an Electronic Control Unit (ECU) and a set of remote nodes, in accordance with an example aspect.

FIG. 2 is a block diagram of examples of the ECU and set of nodes of FIG. 1, in accordance with an example aspect.

FIGS. 3-5 are flow diagrams of an example method for managing data between an ECU and a remote node of a system, in accordance with an example aspect.

FIG. 6 is a timing diagram of an example frame lost scenario in streaming mode, in accordance with an example aspect.

FIG. 7 is a timing diagram of an example out-of-order frame scenario in streaming mode, in accordance with an example aspect.

FIG. 8 is a timing diagram of an example scenario in mailbox mode, in accordance with an example aspect.

FIG. 9 is a timing diagram of an example lost frame scenario in mailbox mode, in accordance with an example aspect.

FIG. 10 is a timing diagram of an example lost frame-burst sending scenario in mailbox mode, in accordance with an example aspect.

FIG. 11 is a timing diagram of an example multicast scenario in mailbox mode, in accordance with an example aspect.

FIG. 12 is a flow diagram of another example method 1200 for managing data between an Electronic Control Unit (ECU) and a remote node of a system, in accordance with an example aspect.

### DETAILED DESCRIPTION

Aspects of the present disclosure are directed to an acknowledgement engine for optimal Ethernet communication to remote nodes. The acknowledgment engine is a hardware based implementation of one or more processors and one or more memories that processes incoming and outgoing communication traffic to distinguish between mailbox data and streaming data and to respond accordingly in each case.

Aspects of the present disclosure are directed to the communication of Protocol Data Units (PDUs). A PDU can be, for example, a packet or a frame. A packet is the PDU at layer 3 (network layer—IP packet) of the networking OSI model. A frame is the PDU of layer 2 (data link) of the OSI model. For the sake of illustration. further description of various aspects of the present disclosure will refer to frames, but can readily be applied to any PDU based on the teachings provided herein.

As noted above, the Ethernet protocol might be subject to out-of-order frames, lost frames, or duplicated frames. One example type of Ethernet networking technology is 10BASE-TIS, in which twisted-pair cables are used for the physical layer communications. 10BASE-T1S is designed for use in automotive and industrial environments where high levels of noise and electromagnetic interference may be present. Ethernet to the Edge Bus (E²B) is an Ethernet protocol, such as for use in a 10BASE-TIS network, which removes the need for a microcontroller (MCU) in the edge node. The present disclosure provides apparatus, methods, and computer-readable media that provide Ethernet communications, such as in an E²B Ethernet implementation, with a robust communication flow between an Electronic Control Unit (ECU) and a remote node, as well as enabling detection of unexpected communication resets of a remote node.

It should be noted that while various aspects of the present disclosure are described primarily with respect to E²B protocol, the present disclosure is not limited to solely E2B protocol and may be used with other Ethernet protocols. Similarly, while one or more aspects of the present disclosure may be described with respect to an automotive application, other applications as described herein and envisioned by one of ordinary skill in the art given the teachings of the present disclosure provided herein may also be used.

In various aspects, an acknowledgement engine of, e.g., E²B technology network, ensures a robust communication flow between an ECU and a remote node by differentiating data types in the communication flow between stream data and mailbox data, each with different requirements.

As used herein, in various aspects, “mailbox data” refers to “robust data” or data that must be received in order and cannot be lost, such as in the case of a dropped frame, if communication integrity is to be maintained. Examples of mailbox data include, but are not limited to, device configuration data (e.g., for configuring a sensor (gyroscope, accelerometer, proximity, etc.) and so forth, device control data (e.g., for controlling a system of a vehicle such as braking, accelerating, or steering, controlling the movements of a manufacturing or warehouse robot, etc.), and any other type of data and/or frame that should be received in full, and received on time, e.g., wherein the data is expected to be lossless from transmission to reception, in order to enable use by the receiving node or application.

In contrast, in various aspects, “streaming data” refers to “non-robust data” or data that can have lost portions, such as in the case of a dropped frame. Examples of streaming data include, but are not limited to, audio data and/or video data such as in an audio/video conferencing call, audio and/or video data in media and/or multimedia playback (e.g., music, programs, movies, and so forth), and any other type of data and/or frame in which losing all or some portion of the data and/or frame is tolerable by the receiving node or application, e.g., wherein at least some data loss is permitted from transmission to reception.

The bandwidth in 10base-T1S networks is very reduced (10 Mbps), and, in some situations, it is desired for the Ethernet network to be ensured that data has been successfully transmitted before sending more data, while in some other situations data can be lost but it is desired for the ECU to be notified of the problem.

In various aspects, the present disclosure solves the above problem of notifying the ECU by setting a flag in a frame header indicating if the data is streaming data or mailbox data, and then behaving differently in each case as described in further detail herein.

In various aspects, in both cases, an extra field called a “sequence number” is added to the frame. The sequence number is a field that is incremented by one for each frame transmitted. The default expected frame after reset is 0, and, in one non-limiting implementation, the value of the sequence number can roll over from 255 to 1. A Listener component/device/node (hereinafter “Listener”) will check that the received number matches the expected number and will generate a message back to a Talker component/device/node (hereinafter “Talker”) if it does not match. This functionality may be used to detect unexpected resets, as the only moment where the Listener expects the next sequence number to be 0 is after a reset of the Talker.

In various aspects, if the data is indicated by the flag as mailbox data, upon reception of a new frame, the Listener will transmit a message back to the Talker including the next expected sequence number. This may be referred to herein as a “positive acknowledgement.” If upon receipt of the next data, the Listener determines that the sequence number of the next data does not match the expected sequence number, then the Listener will discard the data.

In contrast, in various aspects, if the data is indicated by the flag as streaming data, upon reception of a new frame, the Listener will check if the sequence number is the expected sequence number. If so, that is, if the sequence number matches the expected sequence number, then the Listener will process the data. If the sequence number is not the expected sequence number, the Listener will transmit a message back to the Talker including the next expected sequence number. This may be referred to herein as a “negative acknowledgement.” In the situation of an unexpected sequence number, if the sequence number is newer than the expected sequence number, then the Listener will also process the data. If the received sequence number is older than the expected sequence number, then the Listener will discard the data.

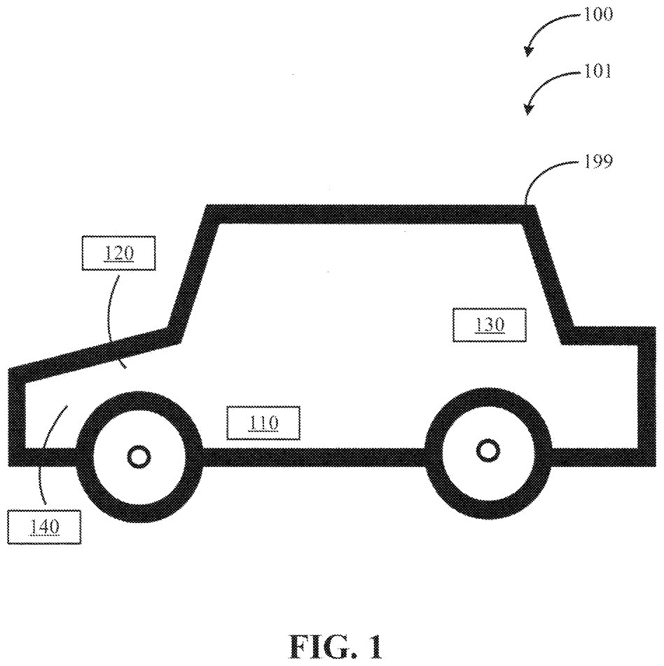

Referring to FIG. 1, an example communication system 100 having an Electronic Controller Unit (ECU) 110 and a set of remote nodes 101 is shown, in accordance with an example aspect. The set of remote nodes 101 includes nodes 120, 130, and 140.

In the example of FIG. 1, the system 100 can be installed in, and correspond to, a vehicle 199. For example, the ECU 110 may be the main controller of the vehicle 199 and the set of remote nodes 101 may correspond to vehicle systems such as steering, accelerating, braking, stability, audio (telephone, music, etc.), lighting, and so forth. However, it is to be appreciated that aspects of the present disclosure are not limited to a vehicle and can be applied to any type of system that includes an ECU and remote nodes such as a robotic system, a surveillance system, a facility access system, and so forth. For example, in the case of a robotic system, the remote nodes 101 can represent motors for controlling movement and arms of robots.

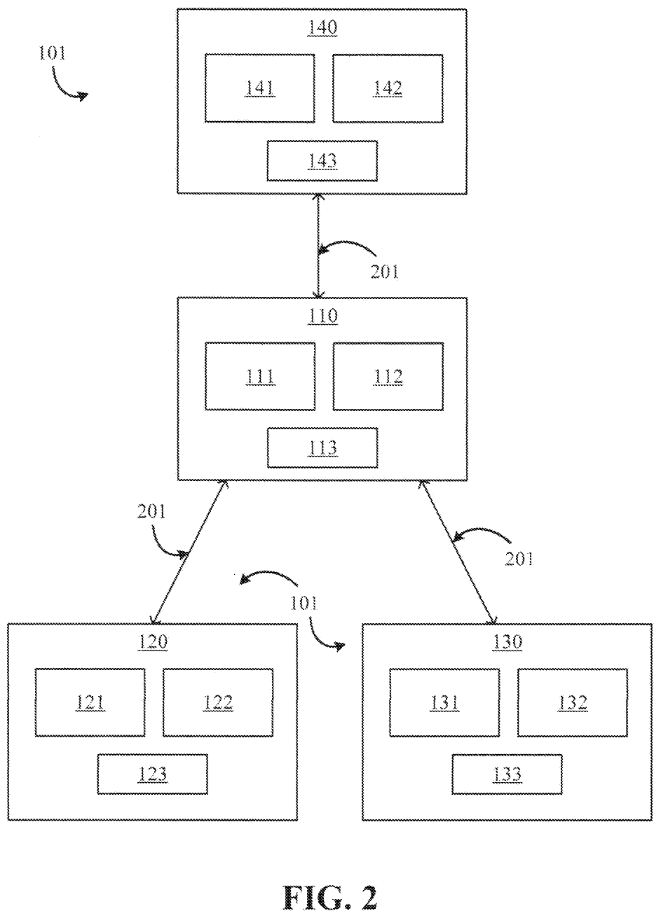

Referring to FIG. 2, examples of the ECU 110 and set of nodes 101 are shown, in accordance with an example aspect.

Each of the ECU 110 and/or the nodes 101 may include one or more memories 1X1 (i.e., ECU 110 includes one or memories 111, remote node 120 includes one or more memories 121, remote node 130 includes one or more memories 131, remote node 140 includes one or more memories 141, and so forth), individually or in combination, having instructions. Each of the ECU 110 and/or the nodes 101 may include one or more processors 1Y2 (i.e., ECU 110 includes one or more processors 112, remote node 120 includes one or more processors 122, remote node 130 includes one or more processors 132, remote node 140 includes one or more processors 142, and so forth) each coupled to at least one of the one or more memories 1X1 and configurable to execute the instructions. In various aspects, ECU 110 is superior to in hierarchy, and provides instructions, for the one or more processors 112, 122, and 132. In various aspects, only ECU 110 includes the one or more memories and one or more processors, and provides signals for controlling the remote nodes 120, 130, and 140.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

In various aspects, ECU 110 and/or remote nodes 101 may include one or more peripherical devices 1X3 (i.e., ECU 110 includes peripheral device(s) 113, remote node 120 includes peripheral device(s) 123, remote node 130 includes peripheral device(s) 133, remote node 140 includes peripheral device(s) 143, and so forth). For example, the ECU 110 may include one or more input devices as peripheral device(s) 113. As a further example, the remote nodes 101 may include one or more motors, lights, speakers, displays, and so forth as peripheral device(s) 123, 133, and/or 143.

ECU 110 and remote nodes 120, 130, and 140 are connected by one or more wires 201. For example, but not limited hereto, any of the following cable types may be used: coaxial; twisted pair; and fiber-optic cabling. In current LANs, the twisted pair cabling is the most popular type of cabling, but the fiber-optic cabling usage is increasing, especially in high performance networks.

A description will now be given regarding various aspects of the present disclosure with respect to example communications between the ECU 110 and one of the remote nodes 101, such as but not limited to remote node 120.

Upon receiving a valid E²B message with the expected sequence number from the ECU 110, the sequence number used by the remote node 120 may be updated to the sequence number of the received message incremented by one, tracked for each topic.

Streaming mode: In streaming mode, the sequence number field is intended to prevent E²B entities from accepting and operating on stale streaming data. The sequence number field also allows E²B entities to deduct out-of-order messages and inform the system 100 (e.g., ECU 110) as configured. For example, if an E²B entity receives a message with a sequence number that does not match the expected updated sequence number on the remote node 120, then the message may be dropped or processed depending on whether the message is stale or not. The remote node 120 may drop the message if the received sequence number is less than the expected sequence number. The remote node 120 may process the message if the received sequence number is greater than the next expected sequence number. In both of these cases, it is intended that the remote node 120 sends a non-acknowledgement message back to the ECU 110 with the correct expected sequence number.

Mailbox mode: In mailbox mode, if an E²B entity receives a message with a sequence number that does not match the next updated sequence number, the remote node 120 drops this message and sends an acknowledgment message with the correct expected sequence number. This acknowledges all previous messages and has the advantage that it conveys more information than just acknowledging each individual message, as it also acknowledges all messages received prior to the current message. If operating in burst mode where many messages are sent before waiting for the corresponding acknowledgement, the system is significantly simplified as lost acknowledgement messages would not matter, thereby leading to a substantial simplification of both Talker and Listener implementations.

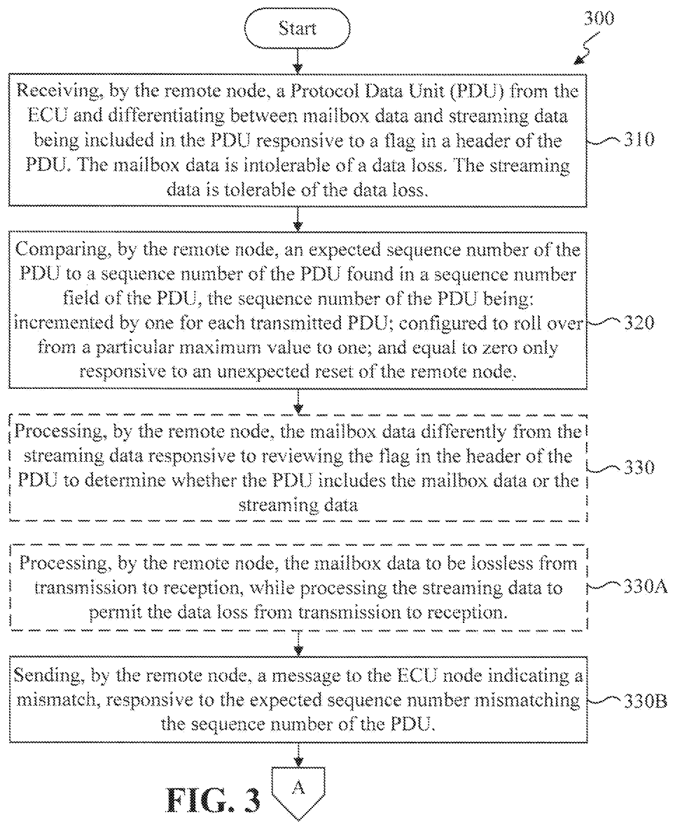

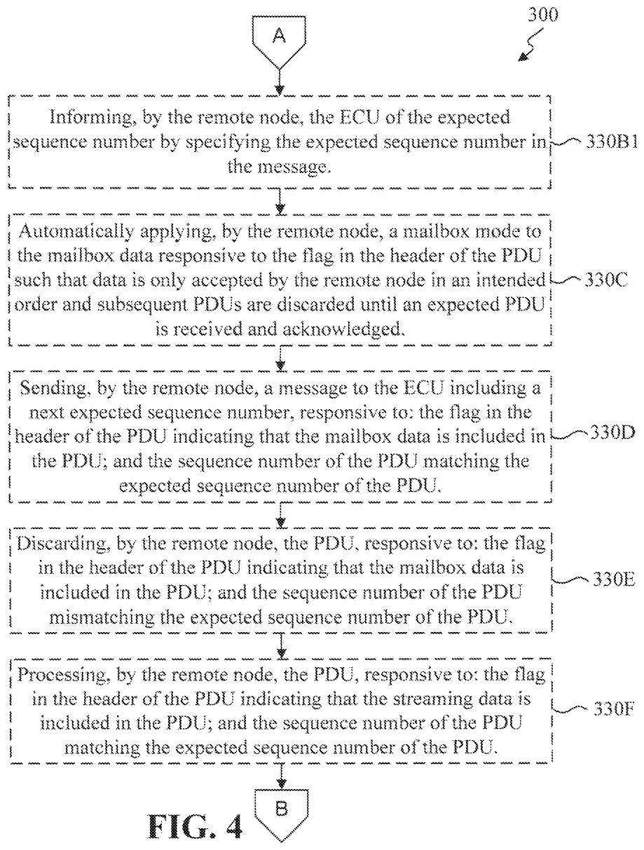

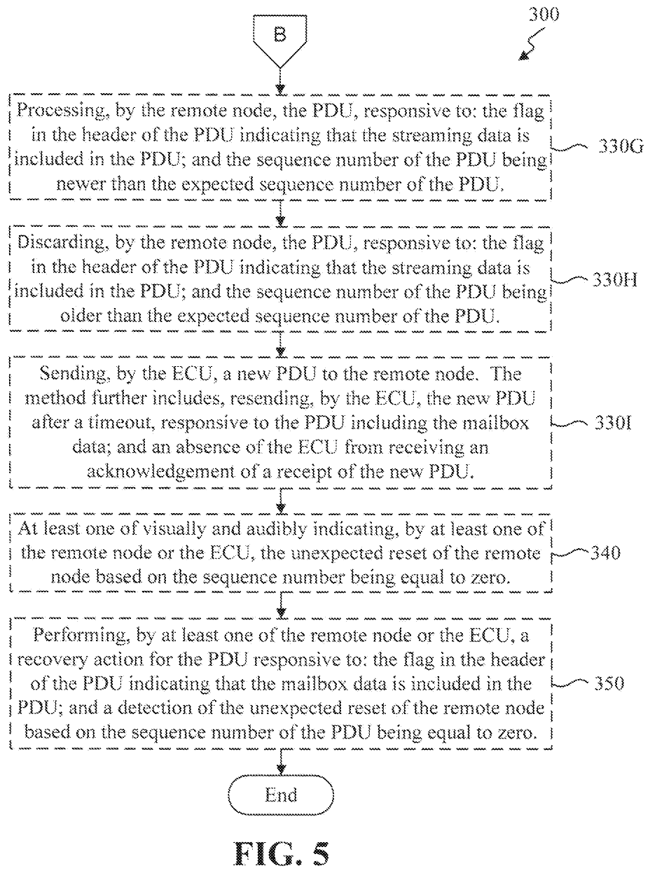

Referring to FIGS. 3-5, an example method 300 is shown for managing data between an Electronic Control Unit (ECU) 110 and a remote node 120 of a system 100. The actions of the method 300 may be performed, for example, by one or any combination of the respective one or more processors 112 and 122, e.g., based on instructions in one or any combination of the respective one or more memories 111 and 121. It should be understood that while method 300 is described with respect to communications between ECU 110 and remote node 120, method 300 include similar communications between ECU 110 and any one or any combination of the remote nodes 101.

At block 310, the method 300 includes receiving, by the remote node 120, a Protocol Data Unit (PDU) from the ECU 110 and differentiating between mailbox data and streaming data being included in the PDU responsive to a flag in a header of the PDU. The mailbox data is intolerable of a data loss. The streaming data is tolerable of the data loss.

In an aspect, the PDU may be received by the remote node 120 in a unicast message sent by the ECU 110 to a remote node 120. In an aspect, the PDU may be received by the remote node 120 in a multicast message sent by the ECU 110 to a plurality of remote nodes 120, 130, and 140.

At block 320, the method 300 includes comparing, by the remote node 120, an expected sequence number of the PDU to a sequence number of the PDU found in a sequence number field of the PDU, the sequence number of the PDU being: incremented by one for each transmitted PDU; configured to roll over from a particular maximum value to one; and equal to zero only responsive to an unexpected reset of the remote node. In an aspect, the particular maximum value of the sequence number may be 255 for the case where the sequence number field is 8 bits. It should be understood that other maximum values can be used. For example, if 16 bits were used for the sequence number field, then the maximum value would be 65536 rolling back to 1.

At block 330, the method 300 includes processing, by the remote node 120, the mailbox data differently from the streaming data responsive to reviewing the flag in the header of the PDU to determine whether the PDU includes the mailbox data or the streaming data

In an aspect, block 330 may include blocks 330A-330I.

At block 330A, the method 300 includes processing, by the remote node 120, the mailbox data to be lossless from transmission to reception, while processing the streaming data to permit the data loss from transmission to reception.

At block 330B, the method 300 includes sending, by the remote node 120, a message to the ECU node indicating a mismatch, responsive to the expected sequence number mismatching the sequence number of the PDU.

In an aspect, block 330B may include block 330B1.

At block 330B1, the method 300 includes informing, by the remote node 120, the ECU 110 of the expected sequence number by specifying the expected sequence number in the message.

At block 330C, the method 300 includes automatically applying, by the remote node 120, a mailbox mode to the mailbox data responsive to the flag in the header of the PDU such that data is only accepted by the remote node 120 in an intended order and subsequent PDUs are discarded until an expected PDU is received and acknowledged.

At block 330D, the method 300 includes sending, by the remote node 120, a message to the ECU 110 including a next expected sequence number, responsive to: the flag in the header of the PDU indicating that the mailbox data is included in the PDU; and the sequence number of the PDU matching the expected sequence number of the PDU.

At block 330E, the method 300 includes discarding, by the remote node, the PDU, responsive to: the flag in the header of the PDU indicating that the mailbox data is included in the PDU; and the sequence number of the PDU mismatching the expected sequence number of the PDU.

At block 330F, the method 300 includes processing, by the remote node 120, the PDU, responsive to: the flag in the header of the PDU indicating that the streaming data is included in the PDU; and the sequence number of the PDU matching the expected sequence number of the PDU.

At block 330G, the method 300 includes processing, by the remote node 120, the PDU, responsive to: the flag in the header of the PDU indicating that the streaming data is included in the PDU; and the sequence number of the PDU being newer than the expected sequence number of the PDU.

At block 330H, the method 300 includes discarding, by the remote node 120. the PDU, responsive to: the flag in the header of the PDU indicating that the streaming data is included in the PDU; and the sequence number of the PDU being older than the expected sequence number of the PDU.

At block 330I, the method 300 includes sending, by the ECU 110, a new PDU to the remote node 120. The method further includes, resending, by the ECU 110, the new PDU after a timeout, responsive to the PDU including the mailbox data; and an absence of the ECU 110 from receiving an acknowledgement of a receipt of the new PDU.

At block 340, the method 300 includes at least one of visually and audibly indicating, by at least one of the remote node 120 or the ECU, the unexpected reset of the remote node based on the sequence number being equal to zero.

At block 350, the method 300 includes performing, by at least one of the remote node 120 or the ECU 110, a recovery action for the PDU responsive to: the flag in the header of the PDU indicating that the mailbox data is included in the PDU; and a detection of the unexpected reset of the remote node based on the sequence number of the PDU being equal to zero.

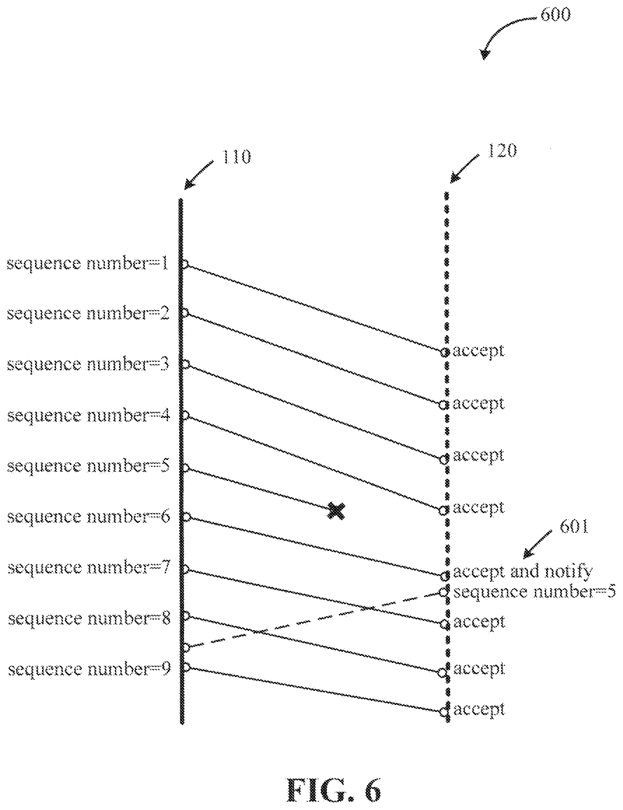

Referring to FIG. 6, an example frame lost scenario 600 in streaming mode of system 100, for example, is shown, in accordance with an example aspect.

In streaming mode, any lost frame from ECU 110 to remote node 120 is typically ignored. However, when newer data than expected is received at remote node 120, an alert message 601 is sent back to ECU 110 to inform ECU 110 that an out-of-sequence message has been received. The ECU 110 could ignore this alert message 601 and continue, or optionally take corrective action at a system level, possibly in the case of several such alert messages being received.

In this scenario 600, the frame corresponding to sequence number 5 is lost in transmission from ECU 110 to remote node 120. The remote node 120 accepts the frame corresponding to sequence number 6 and sends the alert message 601 to ECU 110 notifying ECU 110 that the frame corresponding to sequence number 5 has not been received.

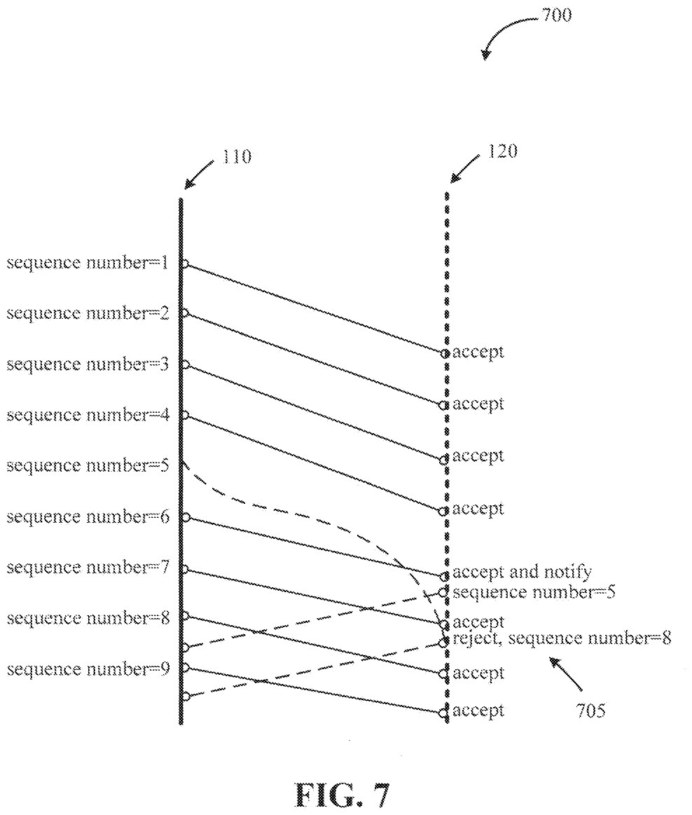

Referring to FIG. 7, an example out-of-order frame scenario 700 in streaming mode of system 100, for example, is shown, in accordance with an example aspect.

In streaming mode, if Protocol Data Units (PDUs) with old sequence numbers are received at the remote node 120, the PDUs are rejected. The remote node 120 sends an alert message 705 to indicate an out-of-order frame.

In this scenario 700, the frame corresponding to sequence number 5 is sent out-of-order (after the frames corresponding to sequence numbers 6 and 7 and before the frame corresponding to sequence number 8). The remote node 120 rejects the frames corresponding to sequence numbers 6 and 7 (and rejects the frame corresponding to sequence number 5 while indicating that the next expected sequence number is 8).

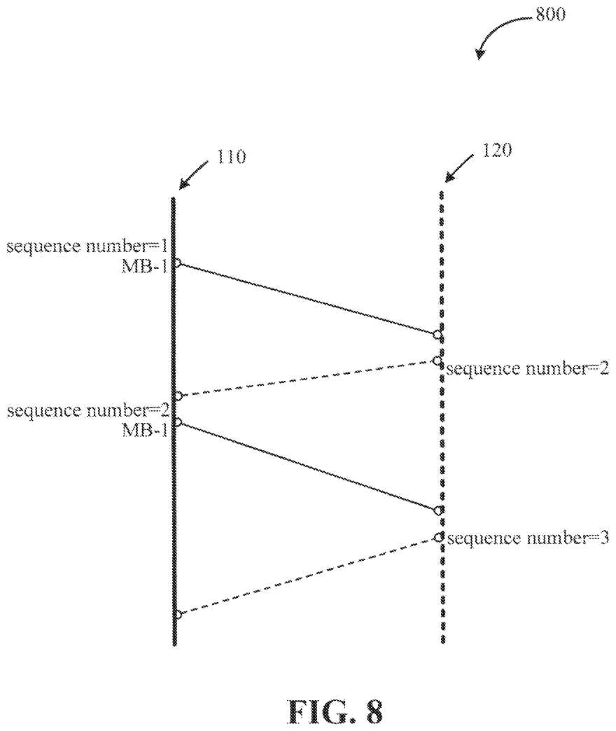

Referring to FIG. 8, an example scenario 800 in mailbox mode of system 100. for example, is shown, in accordance with an example aspect.

In mailbox mode, all EBT PDUs are acknowledged. The remote node 120 sets the sequence number field to the sequence number of the next message that it should receive. This method enables easy recovery in case of system failure, where remote node 120 always sends back the sequence number that it is expected to receive.

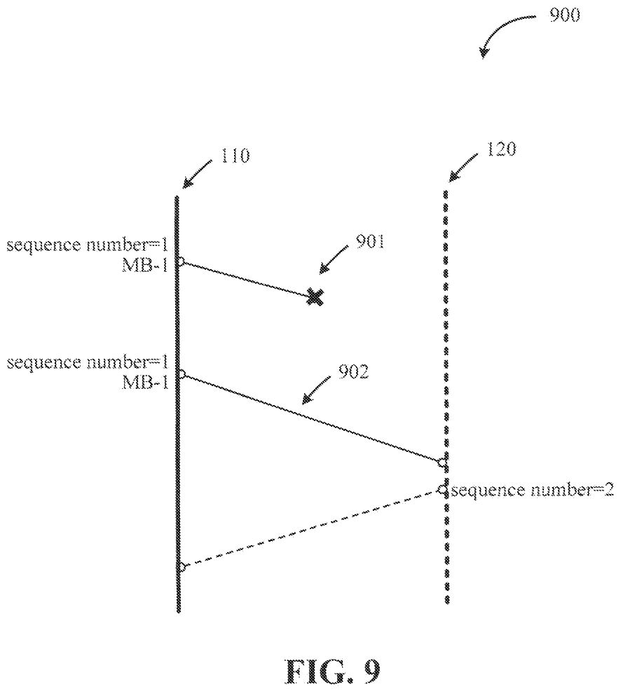

Referring to FIG. 9, an example lost frame scenario 900 in mailbox mode of system 100, for example, is shown, in accordance with an example aspect.

If a frame is lost 901 in transit in mailbox mode, then ECU 110 will not receive an acknowledge message with an acknowledgement sequence number from remote node 120. In such a case, ECU 110 resends 902 the frame after a timeout.

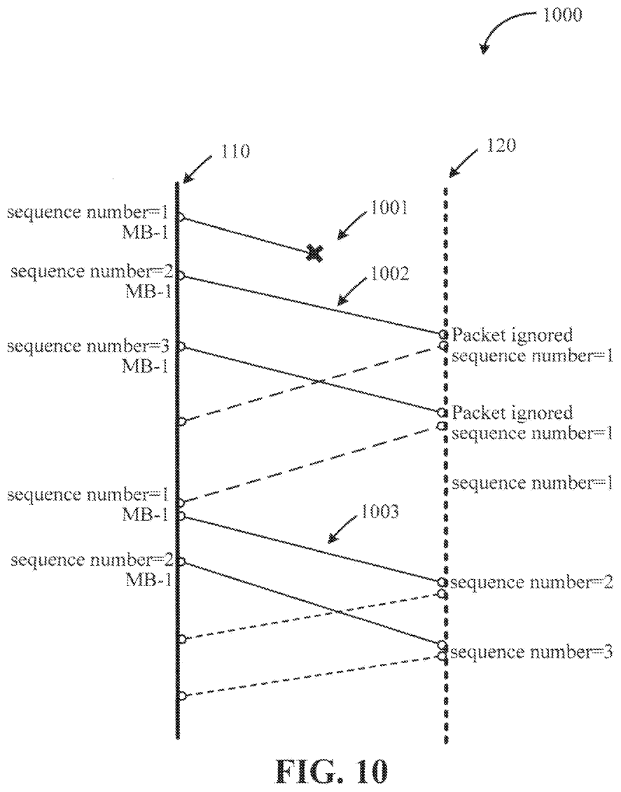

Referring to FIG. 10, an example lost frame-burst sending scenario 1000 in mailbox mode of system 100, for example, is shown, in accordance with an example aspect.

In mailbox mode, when a frame is lost or is received out-of-order, then the frame is not processed. The remote node 120 responds with an acknowledge message with the sequence number set to the sequence number of the next expected message (the lost message). When ECU 110 receives an acknowledge message with the sequence number of the same value as the most recent acknowledge message received, it is interpreted as a lost message and re-transmission is initiated for all subsequent messages starting from the lost message.

In this scenario 1000, the frame corresponding to sequence number 1 is lost 1001. The frames corresponding to sequence numbers 2 and 3 are transmitted by ECU 110 to remote node 120. When the frames corresponding to sequence numbers 2 and 3 are received by remote node 120, remote node 120 responds by ignoring the frames corresponding to sequence numbers 2 and 3 and sending an acknowledge message indicating that the next expected sequence number is 1. The ECU 110 responds by sending 1002 the frame corresponding to sequence number 1. The remote node 120 receives the frame corresponding to sequence number 1 and sends 1003 an acknowledge message indicating that the next expected sequence number is 2.

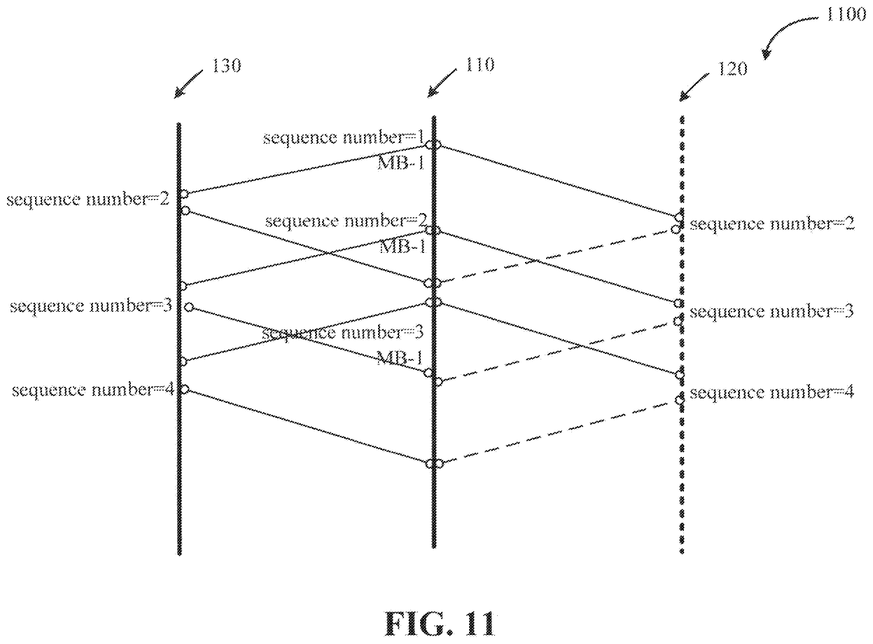

Referring to FIG. 11, an example multicast scenario 1100 in mailbox mode of system 100, for example, is shown, in accordance with an example aspect.

Mailbox messages can also be sent to multicast addresses although having many remote nodes 120 may result in increased traffic on the network.

In this scenario 1100, ECU 110 sends frames corresponding to sequence numbers 1, 2, and 3 to both remote node 120 and remote node 130 using multicast.

Both remote node 120 and remote node 130 receive and process the frames corresponding to sequence numbers 1, 2, and 3 while send immediately after each receipt an acknowledge message indicating a next expected sequence number. Thus, when the frame for sequence number 1 is received by remote node 120 and remote node 130, these nodes send respective acknowledge messages to ECU 110 indicating the next expected sequence number

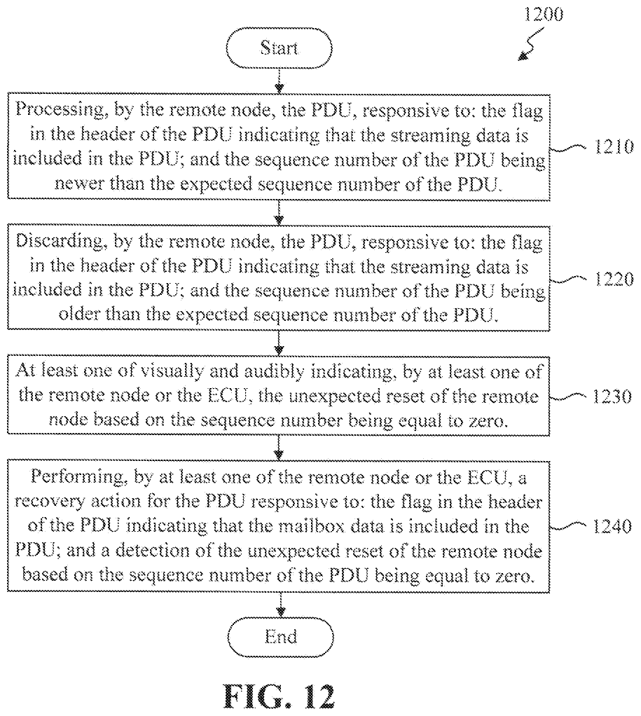

Referring to FIG. 12, another example method 1200 for managing data between an Electronic Control Unit (ECU) and a remote node of a system is shown, in accordance with an example aspect.

At block 1210, the method 1200 includes sending, by the ECU 110, a Protocol Data Unit (PDU) to the remote node 120 and differentiating between mailbox data and streaming data being included in the PDU responsive to a flag in a header of the PDU. The mailbox data is required to be received in order and to be intolerable of a data loss. The streaming data is tolerable of the data loss.

At block 1220, the method 1200 includes receiving, by the ECU 110, a message from the remote node 120 indicating a mismatch, responsive to a sequence number of the PDU mismatching an expected sequence number of the PDU. The sequence number of the PDU is: incremented by one for each transmitted frame, configured to roll over from a particular maximum value to one, and equal to zero only responsive to an unexpected reset of the remote node.

At block 1230, the method 1200 includes at least one of visually and audibly indicating, by at least one of the remote node 120 or the ECU, the unexpected reset of the remote node based on the sequence number being equal to zero.

At block 1240, the method 1200 includes performing, by at least one of the remote node 120 or the ECU 110, a recovery action for the PDU responsive to: the flag in the header of the PDU indicating that the mailbox data is included in the PDU; and a detection of the unexpected reset of the remote node based on the sequence number of the PDU being equal to zero.

Method 1200 can be implemented by a program storage device as described herein. Method 1200 may be performed an ECU such as, e.g., ECU 110.

Aspects of the present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages.

Aspects of the present disclosure are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In various aspects, a computer-implemented method and a computer program product configured to manage data between an Electronic Control Unit (ECU) and a remote node of a system are provided. The computer program product includes one or more non-transitory computer-readable media, having instructions stored thereon that when executed by one or more processors cause the one or more processors, individually or in combination, to perform a method as described herein.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that all of the specifications, dimensions, and relationships outlined herein (e.g., the number of elements, operations, steps, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example aspects have been described with reference to particular component arrangements. Various modifications and changes may be made to such aspects without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system may be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and may accommodate a large number of components, as well as more complicated/sophisticated arrangements and configurations. Accordingly, the examples provided should not limit the scope or inhibit the broad teachings of the electrical circuits as potentially applied to myriad other architectures.

It should also be noted that in this Specification, references to various features (e.g., elements, structures, modules, components, steps, operations, characteristics, etc.) included in “one aspect”, “example aspect”, “an aspect”, “another aspect”, “some aspects”, “various aspects”, “other aspects”. “alternative aspect”, and the like are intended to mean that any such features are included in one or more aspects of the present disclosure, but may or may not necessarily be combined in the same aspects.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

It should also be noted that the functions related to circuit architectures illustrate only some of the possible circuit architecture functions that may be executed by, or within, systems illustrated in the FIGURES. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by aspects described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Note that all optional features of the device and system described above may also be implemented with respect to the method or process described herein and specifics in the examples may be used anywhere in one or more aspects.

The “means for” in these instances (above) may include (but is not limited to) using any suitable component discussed herein, along with any suitable software, circuitry, hub, computer code, logic, algorithms, hardware, controller, interface, link, bus, communication pathway, etc.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that topologies illustrated in and described with reference to the accompanying FIGURES (and their teachings) are readily scalable and may accommodate a large number of components, as well as more complicated/sophisticated arrangements and configurations. Accordingly, the examples provided should not limit the scope or inhibit the broad teachings of the illustrated topologies as potentially applied to myriad other architectures.

It is also important to note that the steps in the preceding flow diagrams illustrate only some of the possible signaling scenarios and patterns that may be executed by, or within, communication systems shown in the FIGURES. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication systems shown in the FIGURES in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges, aspects described herein may be applicable to other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 142 as it exists on the date of the filing hereof unless the words “means for” or “step for” are specifically used in the particular claims; and (b) does not intend, by any statement in the specification, to limit this disclosure in any way that is not otherwise reflected in the appended claims.

1. A computer-implemented method for managing data between an Electronic Control Unit (ECU) and a remote node of a system, the method comprising:
receiving, by the remote node, a Protocol Data Unit (PDU) from the ECU and differentiating between mailbox data and streaming data being included in the PDU responsive to a flag in a header of the PDU, the mailbox data being required to be received in order and to be intolerable of a data loss, the streaming data being tolerable of the data loss;
comparing, by the remote node, a sequence number of the PDU found in a sequence number field of the PDU to an expected sequence number of the PDU, the sequence number of the PDU being: incremented by one for each transmitted frame, configured to roll over from a particular maximum value to one, and equal to zero only responsive to an unexpected reset of the remote node; and
sending, by the remote node, a message to the ECU indicating a mismatch, responsive to the sequence number of the PDU mismatching the expected sequence number.

2. The computer-implemented method of claim 1, further comprising informing, by the remote node, the ECU of the expected sequence number by specifying the expected sequence number in the message.

3. The computer-implemented method of claim 1, further comprising processing, by the remote node, the mailbox data differently from the streaming data responsive to reviewing the flag in the header of the PDU to determine whether the PDU includes the mailbox data or the streaming data.

4. The computer-implemented method of claim 1, wherein the mailbox data is processed to be lossless from transmission to reception, while the streaming data is processed to permit the data loss from transmission to reception.

5. The computer-implemented method of claim 1, wherein in a mailbox mode automatically applied to the mailbox data by the remote node responsive to the flag in the header of the PDU, PDUs are only accepted by the remote node in an intended order such that subsequent PDUs are discarded until an expected PDU is received and acknowledged.

6. The computer-implemented method of claim 1, further comprising sending, by the remote node, a message to the ECU including a next expected sequence number, responsive to: the flag in the header of the PDU indicating that the mailbox data is included in the PDU; and the sequence number of the PDU matching the expected sequence number of the PDU.

7. The computer-implemented method of claim 1, further comprising discarding, by the remote node, the PDU, responsive to: the flag in the header of the PDU indicating that the mailbox data is included in the PDU; and the sequence number of the PDU mismatching the expected sequence number of the PDU.

8. The computer-implemented method of claim 1, further comprising processing, by the remote node, the PDU, responsive to: the flag in the header of the PDU indicating that the streaming data is included in the PDU; and the sequence number of the PDU matching the expected sequence number of the PDU.

9. The computer-implemented method of claim 1, further comprising processing, by the remote node, the PDU, responsive to: the flag in the header of the PDU indicating that the streaming data is included in the PDU; and the sequence number of the PDU being newer than the expected sequence number of the PDU.

10. The computer-implemented method of claim 1, further comprising discarding, by the remote node, the PDU, responsive to: the flag in the header of the PDU indicating that the streaming data is included in the PDU; and the sequence number of the PDU being older than the expected sequence number of the PDU.

11. The computer-implemented method of claim 1, further comprising at least one visually and audibly indicating, by at least one of the remote node or the ECU, the unexpected reset of the remote node based on the sequence number being equal to zero.

12. The computer-implemented method of claim 1, further comprising performing, by at least one of the remote node or the ECU, a recovery action for the PDU responsive to: the flag in the header of the PDU indicating that the mailbox data is included in the PDU; and a detection of the unexpected reset of the remote node based on the sequence number of the PDU being equal to zero.

13. The computer-implemented method of claim 1, further comprising
sending, by the ECU, a new PDU to the remote node;
resending, by the ECU, the new PDU after a timeout, responsive to the PDU including the mailbox data; and an absence of the ECU from receiving an acknowledgement of a receipt of the new PDU.

14. The computer-implemented method of claim 1, wherein the PDU is sent in a multicast message to a plurality of remote nodes.

15. The computer-implemented method of claim 1, wherein the particular maximum value of the sequence number is 255.

16. The computer-implemented method of claim 1, wherein the remote node is configured to communicate with the ECU using an Ethernet to the Edge Bus (E²B) protocol.

17. A computer program product configured to manage data between an Electronic Control Unit (ECU) and a remote node of a system, the computer program product comprising one or more non-transitory computer-readable media, having instructions stored thereon that when executed by one or more processors cause the one or more processors, individually or in combination, to perform a method comprising:
receiving, by the remote node, a Protocol Data Unit (PDU) from the ECU and differentiating between mailbox data and streaming data being included in the PDU responsive to a flag in a header of the PDU, the mailbox data being required to be received in order and to be intolerable of a data loss, the streaming data being tolerable of the data loss;
comparing, by the remote node, a sequence number of the PDU found in a sequence number field of the PDU to an expected sequence number of the PDU, the sequence number of the PDU being: incremented by one for each transmitted frame; configured to roll over from a particular maximum value to one; and equal to zero only responsive to an unexpected reset of the remote node; and
sending, by the remote node, a message to the ECU indicating a mismatch, responsive to the sequence number of the PDU mismatching the expected sequence number.

18. The computer program product of claim 17, wherein the method further comprises informing, by the remote node, the ECU of the expected sequence number by specifying the expected sequence number in the message.

19. The computer program product of claim 17, wherein the method further comprises processing, by the remote node, the mailbox data differently from the streaming data responsive to reviewing the flag in the header of the PDU to determine whether the PDU includes the mailbox data or the streaming data.

20. The computer program product of claim 17, wherein the mailbox data is processed to be lossless from transmission to reception, while the streaming data is processed to permit the data loss from transmission to reception.

21. The computer program product of claim 17, wherein in a mailbox mode automatically applied to the mailbox data by the remote node responsive to the flag in the header of the PDU, data is only accepted by the remote node in an intended order such that subsequent PDUs are discarded until an expected PDU is received and acknowledged.

22. The computer program product of claim 17, wherein the remote node is configured to communicate with the ECU using an Ethernet to the Edge Bus (E²B) protocol.

23. A remote node for communicating with an Electronic Control Unit (ECU) in a system, the remote node comprising:
one or more memories, individually or in combination, having instructions;
one or more processors each coupled to at least one of the one or more memories and configurable to execute the instructions to:
receive a Protocol Data Unit (PDU) from the ECU and differentiating between mailbox data and streaming data being included in the PDU responsive to a flag in a header of the PDU, the mailbox data being required to be received in order and to be intolerable of a data loss, the streaming data being tolerable of the data loss;
compare a sequence number of the PDU found in a sequence number field of the PDU to an expected sequence number of the PDU, the sequence number of the PDU being: incremented by one for each transmitted frame; configured to roll over from a particular maximum value to one; and equal to zero only responsive to an unexpected reset of the remote node; and
send a message to the ECU indicating a mismatch, responsive to the sequence number of the PDU mismatching the expected sequence number.

24. The remote node in accordance with claim 23, wherein the remote node is configured to communicate with the ECU using an Ethernet to the Edge Bus (E²B) protocol.

25. A computer-implemented method for managing data between an Electronic Control Unit (ECU) and a remote node of a system, the method comprising:
sending, by the ECU, a Protocol Data Unit (PDU) to the remote node and differentiating between mailbox data and streaming data being included in the PDU responsive to a flag in a header of the PDU, the mailbox data being required to be received in order and to be intolerable of a data loss, the streaming data being tolerable of the data loss; and
receiving, by the ECU, a message from the remote node indicating a mismatch, responsive to a sequence number of the PDU mismatching an expected sequence number of the PDU, the sequence number of the PDU being: incremented by one for each transmitted frame, configured to roll over from a particular maximum value to one, and equal to zero only responsive to an unexpected reset of the remote node.

26. An Electronic Control Unit (ECU) for communicating with a remote node in a system, the ECU comprising:
one or more memories, individually or in combination, having instructions;
one or more processors each coupled to at least one of the one or more memories and configurable to execute the instructions to:
send a Protocol Data Unit (PDU) to the remote node and differentiating between mailbox data and streaming data being included in the PDU responsive to a flag in a header of the PDU, the mailbox data being required to be received in order and to be intolerable of a data loss, the streaming data being tolerable of the data loss; and
receive a message from the remote node indicating a mismatch, responsive to a sequence number of the PDU mismatching an expected sequence number of the PDU, the sequence number of the PDU being: incremented by one for each transmitted frame, configured to roll over from a particular maximum value to one, and equal to zero only responsive to an unexpected reset of the remote node.
